(19) United States
(12) Patent Application Publication
(10) Pub. No.: US 2005/0101725 A1
(43) Pub. Date: May 12, 2005

(54) Low-formaldehyde thermoplastic seal adhesive

(75) Inventor: Brian P. Carney, Erie, PA (US)

Correspondence Address: LORD CORPORATION;PATENT & LEGAL SERVICES, 111 LORD DRIVE, CARY, NC, 27512, US

(73) Assignee: Lord Corporation

(21) Appl. No.: 10/706,236

(22) Filed: Nov. 12, 2003

(51) Int. Cl. C08K 3/34; C08K 3/04; C08K 3/00

(52) U.S. Cl. 524/594; 524/492; 524/495

(57) ABSTRACT

Disclosed are aqueous adhesives compositions which emit low residual formaldehyde and suitable for bonding rubbers to a metal substrate under pre-bake conditions. The adhesive composition comprises a phenolic novolak, acid acceptor and chlorinated natural rubber, absent an organic crosslinker. Preferably the adhesive further comprises precipitated silica and/or carbon black. Also disclosed are composites of rubber bonded to metal, such as seals, gaskets, and linings Effective bonds possessing excellent environmental resistance can be obtained in single coats resulting in rubber-tear failure from the rubber-metal bond.

### FIELD OF THE INVENTION

The invention pertains to adhesives useful in bonding rubber to substrates such as metal, a method for bonding of rubber to metal, and bonded rubber-metal composites such as seals and gaskets. The adhesive provides environmentally-resistant bonding performance when applied under varied molding operating conditions.

### BACKGROUND OF THE INVENTION

Dynamic seals comprise rubber bonded to metal plates, rings and the like, and are essential for sealing fluids in devices, especially crankshafts, transmissions, water pumps, brake systems, oil pan gaskets, head gaskets, and exhaust manifold gaskets. In modern vehicles, these seals are composed of a compounded elastomer that is adhered to a metal support by an adhesive. The elastomer selected is primarily based upon its ability to resist the fluid to which it will be exposed, and other technical factors such as dimensional stability, compression set, tear resistance and Durometer hardness. The adhesive is applied as a thin coating, typically less than 0.001 in. (0.025 mm) dry film thickness (DFT) to the metal substrate and dried, but not cured. The coated metal parts are placed in a multi-cavity rubber mold frame. Compounded, curable elastomer of choice is transferred to the mold cavities and molded takes place by conventional methods, such as, compression molding, injection molding, transfer molding, followed by curing of the elastomer.

Sulfur-cured nitrile elastomers (NBR) are a dominant type of elastomer used in seals. Other elastomers used for seals include olefin-acrylates, and fluoroelastomers. Representative olefin-acrylates include acrylic-ethylene acid copolymers that can be cured with diamines and/or peroxides. These elastomers are cured upon molding to the base metal substrate, typically cold rolled steel. While the rubber is curing (e.g. at 150° C.-200° C.) the bonding of rubber to metal occurs as the adhesive cures.

U.S. Pat. No. 4,167,500 to Jazenski describes an aqueous adhesive composition that contains an aqueous novolak phenolic dispersion, methylene donor organic crosslinker, and water. These adhesives exhibit good shelf-stability compared with heat-reactive resoles. Formation of seals using this type of adhesive, where the adhesive experiences pre-bake temperatures of about 150° C. for minutes prior to adhesive contact with the injected curable elastomer results in less than desired level of rubber-cohesive bond failure. That is, an unacceptable bond area fails other then entirely within the cured elastomer, such as rubber-cement, or cement-metal failure under destructive peel testing. The extent of an adhesive's ability to withstand pre-bake temperatures for as long as necessary and provide a high percentage of rubber cohesive failure is referred to as pre-bake resistance.

U.S. Pat. No. 4,196,140 discloses adhesive useful for bonding elastomers adhesion promoting compositions of the present invention comprise (a) at least one phenolic novolak resin; (b) at least one polyepoxide characterized by the presence of at least two epoxy groups; and (c) an effective amount of at least one organic crosslinking agent.

The phenolic novolak resins employed are well-known acid catalyzed phenol-aldehyde condensates with a formaldehyde/phenol molar ratio of less than 1, referred to as novolak resins. The novolak resins are not self-curing, and are converted to an infusible state by organic crosslinking agents such as hexamethylenetetramine, di-nitroso compounds, dioximes, formaldehyde donors, to name a few of the many organic crosslinkers for phenolic resins.

U.S. Pat. No. 4,236,564 discloses a rubber-free adhesive useful for bonding bright steel fibers to rubber. The adhesive is characterized as rubber-free adhesive containing an adhesion-improving amount of a phenolic resin silica. The phenolic resin in its uncured state is selected from the class consisting of a heat reactive phenolic resin, and heat reactive phenolic resin in combination with non-heat reactive phenolic resin, wherein the ratio of the phenol to formaldehyde in the resin is from 1:1 to 1:6.

U.S. Pat. No. 3,878,134 describes adhesives for the production of composites by vulcanization of rubber mixtures onto metals or other stable substrates. The suitable binders taught include chlorosulfonated polyethylene, chlorinated rubber, polyisocyanates and a phenolic resin. The organic crosslinker employed is dinitrosobenzene. Experience has shown that an adhesive of this type suffers from low pre-bake resistance.

U.S. Pat. No. 5,200,455 teaches aqueous adhesive primer, used with a covercoat adhesive, and containing polyvinyl alcohol-stabilized aqueous phenolic resin dispersion, a latex of a halogenated polyolefin, and a metal oxide. The phenolic resin dispersion is prepared by mixing (a) a pre-formed, solid substantially water-insoluble, phenolic resin; (b) water; (c) an organic coupling solvent; and (d) polyvinyl alcohol, at a temperature and for a period of time sufficient to form a dispersion of said phenolic resin in water. The aqueous primer composition substantially reduces the utilization of organic solvents, is said to provide pre-bake resistance, and robust environmentally resistant adhesive bonds.

An aqueous adhesive disclosed in U.S. Pat. No. 5,354,805 is said to be particularly effective in bonding nitrile rubber to metal and contains chlorosulfonated polyethylene latex, a polyhydroxy phenolic resin copolymer, and an aldehyde donor, such as (gamma-POM) γ-polyoxoymethylene as organic crosslinker. The adhesive composition is shown to have excellent initial adhesion and provides environmentally resistant bonds.

U.S. Pat. No. 5,385,979 discloses adhesive compositions useful as one-coat or primer-cover coats based on chlorinated poly(mono)olefins having chlorine content greater than about 60 percent and a heat reactive phenolic resin. The chlorinated poly(mono)olefin is taught as a substitute for chlorinated natural rubber materials without compromising adhesive performance. The '979 patent teaches in the case of employing a phenolic novolak resin a formaldehyde crosslinker source is required, such as paraformaldehyde, s-trioxane, hexamethylene tetramine, anhydrofor-maldehydeaniline, ethylene diamine formaldehyde; methylol derivatives of urea and formaldehyde; acetaldehyde; furfural; methylol phenolic compounds; and the like. These organic compounds are considered methylene donors in that they effect rapid crosslinking of heat fusible novolac resins with methylene or equivalent linkages by the application of heat.

Copending U.S. application Ser. No. 09/894,751 discloses an aqueous adhesive composition, comprising a phenolic novolak or resole resin, a chlorinated natural rubber, a precipitated silica, and a zinc or calcium oxide, phosphate, or carbonate reactive fillers. In the use of a phenolic novolak, this disclosure teaches the use of an organic crosslinking agent.

In the formation of metal seals, it is typical to encounter delays in the molding of the adhesive treated metal (pre-bake) for several minutes. A well-known solvent-borne adhesive, CHEMLOK® 205 is an established industry standard and provides high rubber-retention bonds while also exhibiting pre-bake resistance. Aqueous adhesives exhibiting improved pre-bake resistance while not sacrificing environmental resistance are sought.

### SUMMARY OF THE INVENTION

The present invention is an aqueous adhesive composition for bonding vulcanizable rubbers, in particular, NBR and olefin-acrylate type elastomers. The adhesive provides rubber-cohesive failure in bonds to metal substrates. A high degree of rubber cohesive failure is obtained after exposure to harsh environmental stress is applied to the adhesive bonded composite. The vulcanizable elastomers bonded according to the invention exhibit rubber cohesive failure to metal surfaces under pre-bake conditions. The adhesive is substantially absent an organic crosslinker, and comprises water as carrier, chlorinated natural rubber dispersion, a phenolic novolak resin (F/P ratio<1), an acid acceptor, and one or more optional inorganic pigments and/or fillers including but not limited to silica, titanium dioxide, and/or carbon black, and dispersing agents.

In accordance with another aspect the present invention is further directed to a method of bonding vulcanizable elastomer to a metallic surface comprising coating the metal substrate with the adhesive composition according to the invention, drying the adhesive composition, joining a vulcanizable elastomer to the adhesive-coated metal substrate, and curing the assembly in a mold under heat and/or pressure.

In accordance with another aspect, the present invention is directed to a molded rubber-metal seal comprising a shaped vulcanized elastomer conforming to a portion of a metal seal substrate, and interposed between the metal surface and vulcanized elastomer is layer of adhesive having a film thickness of from 0.0003-0.001 in (0.0076-0.025 mm) the adhesive comprising, in the absence of an organic crosslinker, a mixture of chlorinated natural rubber, a phenolic novolak (F/P<1), and an acid acceptor.

The preferred aqueous adhesive consists essentially of water, chlorinated natural rubber latex, a dispersed phenolic novolak, a metal salt or oxide, wherein the adhesive is absent an organic crosslinker or self-crosslinking phenolic.

In another aspect, the invention is directed to a method for bonding an elastomer to metal, comprising applying a single coating of the adhesive according to the invention and drying the adhesive to a dry film thickness of from 0.0003-0.001 in (0.0076-0.025 mm), holding said adhesive at an elevated pre-bake temperature of at least 300° F. (149° C.), contacting a curable elastomer with the surface of the adhesive on said metal substrate and curing the elastomer.

The invention is particularly adaptable for the manufacture of dynamic seals which comprise thin metal stampings of a variety of designed patterns dimensioned to overlie shafts, chambers, etc, especially including circular stampings, such as a rings, discs, and flanged rings. At least part of the surface of metal is bonded to a curable/vulcanizable elastomer molded to conform to the to-be-bonded portion of the metal surface. The adhesive exhibits the capability to provide environmentally resistant bonds in a single adhesive layer applied to the metal surface, upon drying the adhesive.

### BRIEF DESCRIPTION OF THE DRAWING

FIG. 1 is a photograph of various rubber-bonded composite seals made according to the invention.

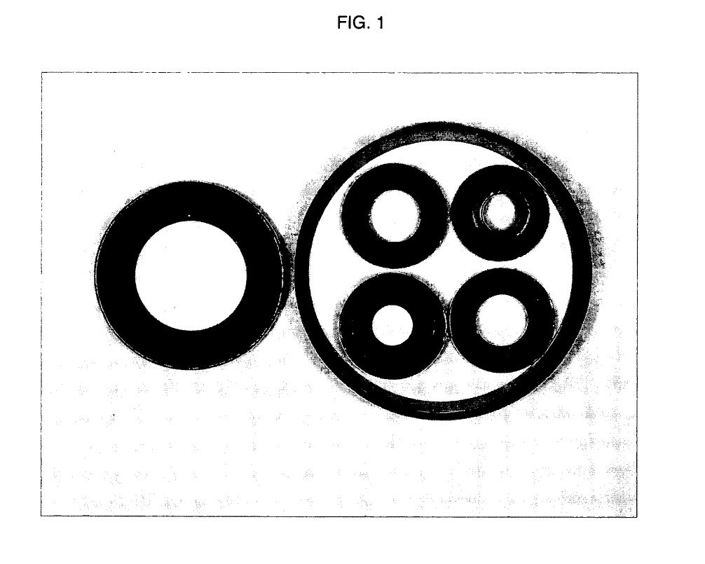

### DETAILED DESCRIPTION OF THE PREFERRED EMBODIMENTS

Pre-bake resistance in an adhesive is defined as a capability of tolerating a pre-heating cycle up to 10-30 minutes or more at or above 300° F. (149° C.) prior to contact of a vulcanizable rubber to the adhesive coated metal substrate. Pre-bake resistance in the adhesive means that the adhesive can withstand the heat exposure period without losing significant adhesive performance. Adhesive performance is illustrated by the extent of rubber-tearing bonds to the metal after vulcanization. Metal coupons or plaques are used for this purpose. Rubber tear is a cohesive failure in the rubber evidencing that the adhesive bond-line between the metal and elastomer is stronger than the cohesive strength of the elastomer itself. Such rubber cohesive failure is quantitatively evaluated by observing the percentage of the bond area having rubber retention on the metal part after destructive peeling of the rubber from the metal.

Pre-bake resistance is a measure of adhesive bonding performance after a delay from the time the adhesive coated metal parts are heated to contact with the adhesive and curable elastomer. The pre-bake delay is evaluated typically after 5, 10, 15, minutes up to as much as 60 minutes, with a heat exposure for the adhesive coated metal at 149-193° C. Rubber cohesive failure (rubber retained over the adhesive bond area) under pre-bake conditions is ideal. Failure between the cement (adhesive) and the rubber (RC) or between the cement and the metal surface (CM are unacceptable failure modes, and if the percentage of area in the bond line having RC or CM failure is above about 20% or more, this indicates suboptimum performance. Adequate bonding is seen by at least about 70% rubber retention to the adhesive coated metal substrate, over the bond area, and preferably about 80% or higher of rubber retention, ideally 100% rubber retention.

A high percentage of rubber cohesive failure over the bonded area is provided when the dried film of adhesive remains firmly adhered to the metal surface and is referred to as resistance to sweeping by the vulcanizable rubber flowing over the inserted metal substrate in the mold cavity.

Phenolic resin manufacture, and aqueous dispersions of phenolic resins are widely varying in the art. Condensation of the phenolic compound(s) with an aldehyde or aldehyde source, typically formaldehyde, which condenses with the phenolic precursors compounds, or intermediates to form a novolak phenolic resins. A novolak precursor resin may be used and further chain extended with one or more phenolic monomers, and/or additional aldehyde. A source which liberates aldehyde in situ, can be used such as by employing a resole. The reaction typically is acid catalyzed with an acid such as phosphoric acid. A typical F/P ratio of aldehyde to phenolic components in the final reaction product ranges from 0.5 to 0.9. Hydrophilic novolaks typically have a hydroxy equivalents of between 1 and 3 per aromatic ring and are suitable for use herein. Preferably, a dispersed hydrophilic novolak contains a hydroxy equivalent of 1.1 to 2.5, more preferably 1.1 to 2.0. The hydroxy equivalent is a known characterization calculated on the amount of multi-hydroxy phenolic compounds used to make the novolak.

The novolak resin backbone may be based on monohydroxy-, polyhydroxy- and both mononydroxy and polyhydroxy phenols, as a single condensate, co-condensate or mixture of resins with an overall F/P ratio of less than 1. The phenolic monomers can contain substituted rings, or unsubstituted rings. Among the substituent groups which can be attached to the nucleus of any of the phenolic compound starting materials are hydrogen, alkyl, aryl, alkyl substituted aryl, aryl substituted alkyl, alkoxy, carboxy, alkoxy, amide, imide, halogen or the like. Representative starting phenolic compounds include, without limitation, phenol, p-t-butylphenol, p-phenylphenol, p-chlorophenol, p-alkoxyphenol, o-cresol, m-cresol, o-chlorophenol, m-bromophenol, 2-ethylphenol, amyl phenol, nonyl phenol, cashew nut shell liquid, resorcinol, orcinol, phloroglucinol, pyrocatechol, pyrogallol, salicylic acid, bis-phenol A, bis-phenol S, gallates such as propyl gallate, robinerin, baptigenin and anthragallol. Sulfonate functional phenolic monomers such as naphthalene sulfonate can be used in minor amounts up to 20 wt. %.

Aqueous phenolic novolak resin employed in the practice of this invention can be a condensate of one or more phenolic starting materials, a co-condensate, or mixture of different resins. The overall composition which generally defines a novolak is a resin composition having a formaldehyde/phenol (F/P) ratio of less than 1. Aqueous dispersed phenolic resin, having a solids content of from 25% to 75% can be made by dilution with water following the condensation reaction. Introduction of an organic colloidal stabilizing system is not necessary or desirable where a co-solvent, such as alcohol, glycol ether, or ketone and water can be used. Colloidal stabilizers such as hydrolyzed PVA (polyvinyl alcohol), sodium caseinate, lignosulfonates, anionic colloidal dispersants such as alkali or ammonium salts of a polyacrylic acids and/or a substituted polyacrylic acids, render the bonding obtained with the adhesive of the present invention more susceptible to environmental stress.

A example specific embodiment novolak resin comprises an aldehyde condensate of one or more than one monohydroxy phenolic compound, a polyhydroxy phenolic compound such as resorcinol, phloroglucinol, pyrocatechol, 6,7-dihydroxy-2-naphthalenesulfonate (DHNS) and/or pyrogallol and the like, with resorcinol and/or pyrocatechol being preferred. A combination of pyrogallol and resorcinol condensed using formaldehyde is a particularly preferred novolak. A preformed aqueous pyrocatechol resin chain extended with resorcinol is a preferred novolak resin. In another example resin, a resole precursor(s), and multi-hydroxy phenolic compound(s) are co-condensed to form a dispersed novolak. The reaction typically is acid catalyzed with an acid such as phosphoric acid. The F/P ratio of aldehyde compound(s) to combined amount of resole precursor(s) and multi-hydroxy phenolic compound(s) in the final reaction mixture preferably is less than 0.9. A typical condensation reaction is carried out in water under conventional phenolic resin condensation techniques and conditions. The reactant mixture (including water) generally is heated from 50 to 100° C. under ambient pressure, although the specific temperature may differ considerably depending upon the specific reactants and the desired reaction product. A resulting resin product is a concentrate that is self-dispersible upon adding more water, and optionally a base, under agitation to reach a desired solids content.

A suitable phenolic novolak resin embodiment is a condensate of 50 to 98 mol percent, preferably 60 to 98 mol percent polyhydroxy phenol and from 50 to 2, preferably 40 to about 2 mol percent of a unsubstituted monohydric phenol, based on 100 mol % of phenolic precursors.

Another suitable phenolic novolak resin utilized herein is a formaldehyde condensate of a mixture of phenolic compounds from 10 to 98, preferably 50 to 98 mol percent of a polyhydroxy phenol and from 90 to 2, preferably 50 to 2 mol percent of a substituted monohydric phenol, the nucleus of which is substituted with at least one alkyl, aryl, alkylaryl, arylalkyl carboxy, alkoxy, amide, imide, or halogen group having from 1 to 20 carbon atoms, and having an F/P<1.

Another suitable phenol novolak resin utilized herein is a formaldehyde condensate of 100 mol percent of one or more than one substituted monohydric phenol, the ring substitutent(s) containing a substituted or unsubstituted alkyl group having from 1 to 20 carbon atoms, and having an F/P<1.

A suitable phenolic novolak resin can be made by condensation of a preformed phenolic resole or phenolic novolak with at least one phenolic and optional formaldehyde. In this case, it is preferred that such additional phenolic compound be selected from the group consisting of polyhydroxy phenols and monohydroxy phenols, the nucleus of which is substituted with at least one substituted or unsubstituted alkyl group having from 1 to 20 carbon atoms.

The most preferred adhesive per se comprises chlorinated natural rubber latex, an acid acceptor and a phenolic novolak which self-disperses in water in the absence of a colloidal stabilizer. The preferred self-dispersible novolak resins have a molecular weight of from 500 to 3000 and have an F/P ratio of from 0.5-0.8, and remain stable as 25-75 wt. % dispersions in water and optional co-solvent by adjusting the pH upwards using a base. The most preferred phenolic novolak is the condensation product of a mono hydroxy phenol compound and/or dihydroxy phenol compound, a trihydroxy phenol compound and an aldehyde. A specific example of the most preferred novolak resin is a pyrogallol-resorcinol-formaldehyde condensate, having a molecular weight of from 500-1500, wherein respective ratio of the starting components is about 2-5 mol % pyrogallol, 90-98 mol % resorcinol and 50-90 mol % formaldehyde, more preferably 50-70 mol % formaldehyde. In a most preferred embodiment, the mole ratio of these components, respectively, is 0.04/0.96/0.60, (F/P=0.6) and prepared according to the following procedure. Reference to parts means parts by weight. To a jacketed vessel equipped with agitation, heating and cooling, are added 100 parts of deionized water, 139 parts 1-methoxy-2-propanol, and 0.1 parts of phosphoric acid. While stirring and heating the contents of the vessel, 371 parts of resorcinol and 22 parts of pyrogallol are added. The contents are heated and stirred until the temperature reaches 90° C. and pyrogallol and resorcinol dissolve. Through a port in the vessel, 190 parts of formalin solution (37% aqueous solution) are added at a constant rate over a period of 30 minutes to one hour. After the addition of the formalin is complete, the resin is maintained for one hour at 95° C. To the resulting resin is then added 105 parts of deionized water to bring the final solids content to approximately 45 weight percent. This novolak resin was used in examples 1, 2, 3-A, 3-E, 3-F, and 3-G, illustrated below.

The novolak resin, absent organic crosslinker is not seen to crosslink prematurely under pre-bake conditions in forming composites of vulcanized elastomers and metal substrate. It is believed that the effectiveness of the adhesive containing a phenolic novolak resin in the absence of organic crosslinking agent is that curing mechanisms in the adhesive do not occur to a significant extent during an initial induction period which can be several minutes at 300° F., up to 30 minutes at 350° F. during a pre-bake, but surprisingly provide environmentally-resistant bonding performance under sever tests, shown below.

In forming the water-based adhesive compositions of the present invention, the phenolic novolak resin dispersion, chlorinated natural rubber latex, and water are combined with dispersions of powdered metal compound. The solids may be pre-dispersed as in a pigment grind conveniently in a masterbatch. The initial adhesive product can be provided as a concentrate and conveniently diluted with water for controlling the desired DFT. The typical percent nonovolatiles of a concentrate can range from 20 to 40% by wt. and the solids level for applying to metal substrates can vary anywhere below the level of the initial solids, e.g. approximately from 5 to 40% depending on the application method and desired dry film thickness.

The preferred aqueous adhesive contains the following on a weight percentage:

| | |
|---|---|
| water | 60-70% |
| phenol novolak | 5-15% solids basis |
| chlorinated natural rubber latex | 5-15% solids basis |
| metal oxide | 2-10% solids basis |
| optional silica | 0-10% solids basis |
| optional carbon black | 0-2% solids basis |
| dispersant | 0-0.5%, preferably 0.1-0.5 |

The type of halogenated polymer film-former used was found to significantly affect adhesive performance when the adhesive was subjected to pre-bake conditions. Of the many known halogenated film formers that could be employed, chlorinated natural rubber surprisingly provided comparatively improved adhesion between metal and a cured elastomer and pre-bake resistance. Chlorinated natural rubber latex is commercially available, for example, from Bayer Aktiengesellschaft, under the PERGUT® mark, and from Lord Corporation under the Chemlok® 7041-19 designation. A typical chlorine level in chlorinated natural rubber is 50 to 75%, preferably 60 to 75 wt. %.

Another essential component of the adhesive is an acid acceptor. Acid acceptors facilitate curing between the adhesive and elastomer may provide more than one function, such as anti-corrosive properties. Acid acceptors include epoxy resins, inorganic oxides, phosphates and/or other salts of zinc, calcium, magnesium, iron, nickel, cobalt, copper, aluminum, and lead-containing compounds including mixtures. Examples of suitable lead-containing compounds include polybasic lead salts of phosphorous acid, saturated and unsaturated organic dicarboxylic acids and acid anhydrides. Specific examples of lead salts include dibasic lead phthalate, monohydrous tribasic lead maleate, tetrabasic lead fumarate, dibasic lead phosphite, lead carbonate, lead oxide and lead dioxide. For environmental reasons, the metal oxides, absent lead are preferred, including oxides, phosphates, and/or carbonates of magnesium, zinc, and aluminum, and mixtures. An aluminum phosphate-zinc oxide mixture is suitable. Zinc oxide is most preferred. The metal compound, depending upon type can suitably be included in an amount generally from about 15 to about 60 parts by weight and desirably from about 25 to about 40 parts by weight per 100 parts by weight of the phenolic novolak dispersion solids.

Accelerator can be employed optionally, such as in conjunction with ZnO, but preferably, for maximum pre-bake resistance an accelerator is not present in the adhesive, but often is present in the curable elastomer, and its presence there has positive effects on aiding in adhesion to the adhesive. If used in the adhesive, the amount of accelerator is low, on the order of less than 2 wt. %. Examples of accelerators include 2,6-di-tert-butyl-para-cresol; N,N′-diethylthiourea; di-ortho-tolylguanidine; 2-mercapto-benzothiazole; benzothiazole disulfide; N-phenyl-beta-naphthylamine; tetramethyl thiuram disulfide, zinc diethyldithiocarbamate, zinc dibutyidithiocarbamate, and zinc dimethyldithiocarbamate. An exemplary mixed metal additive comprises MgO, ZnO and zinc diethyl-dithiocarbamate.

To aid in maintaining a stable aqueous dispersion of solid particulates, these are usually dispersed with one or more dispersing agent which has surface active properties. Preferred such agents are those which form insoluble solids after curing. Suitable dispersing agents include polyacrylic acids, naphthalenesulfonate-formaldehyde condensates, lignosulphonate wood byproducts, and the like. Lignosulfonate wood byproducts are available under the Marasperse® designation, ex. Ligno Tech, Rothchild, Wis. The effective amount of dispersing agent can range from 0.1 to about 5.0% by weight based on total solids. Rheology modifiers optionally used include fumed silica, ammonium salts of polyacrylic acid, and the like. An effective amount of rheology modifier depends upon the type chosen, and can range from as little as 0.2 wt. % on a solids basis, to about 1-2 wt. %. Dry film thickness (DFT) is controlled by the percent solids, and wet coating thickness, and is effective for metal to elastomer bonding typically in a range of from 0.25 to 0.8 mils (7 μm-20 μm), preferably 0.0003-0.0008 in (0.0076-0.02 mm). The adhesive can be easily prepared with a total solids content of from about 20% to 40% by weight. In the absence of a rheology modifier, a typical adhesive viscosity at 15-25% TSC is from 10-100 cps using Brookfield #2 at 30 RPM. Such a viscosity range provides an adhesive at the desired solids content well suited for dipping and spraying metal seal substrates, leaving a preferred DFT of from 0.0003-0.0008 in. (0.0076-0.020 mm).

Sweep resistance i.e, resistance of the adhesive against the flow of injected rubber across the substrate, can be enhanced by employing in the adhesive such as particulate silica. Preferred are precipitated silicas and more preferably, amorphous precipitated silicas. Precipitated silicas are particles approximately spherical in shape and have an average diameter of from about 0.005 or about 0.010 to about 0.030, or about 0.050, or about 0.100 and desirably from about 0.015 to about 0.025 micrometers. The surface area is generally from about 130 to about 170 and preferably from about 140 to about 150 square meters per gram. Examples of such commercially available precipitated silicas include Cabosil® CP304 made by Cabot Corporation of Kokoma, Ind.; Aerosil® 200 made by Degussa Corporation of Ridgefield Park, N.J. with various products under the HiSil® mark, such as HiSil® 233 made by PPG of Pittsburgh, Pa., being especially preferred.

Preferred precipitated silicas, for example HiSil® 233 as well as other HiSil ®200 series silicas are synthetic white, amorphous silicon dioxide powders and pellets. The wet-processed types are hydrated silicas because they are produced by reaction in a water solution from which they precipitate as ultra-fine, agglomerates of spherical particles having an average diameter as noted previously. The surface areas of suitable precipitated silicas is preferably in the aforementioned range. Generally, less than 0.03% by weight of residual particles are retained on a 100 mesh U.S. standard screen. A suitable amount of precipitated silica on adhesive dry weight basis is generally from about 1.5 wt. % to about 10 wt. %, and desirably from about 2 wt. % to 5 wt. % on total adhesive solids.

The adhesive bonds rubber to most surfaces having a surface tension of at least 50 dyn/cm², however outstanding features of the invention are in bonding sulfur-cured NBR elastomers to metal, and amine-cured ethylene-acrylate elastomers to metal. Any surface which the adhesive wets out such as glass, thermoplastic, fiber-reinforced thermoplastic, structural thermoplastics, RFL-treated glass fiber rovings such as used in reinforced rubber belts and hoses, fabric surfaces is suitable Suitable metal substrates in general include conventional structural metals such as iron, steel (including stainless steel, cold-rolled steel, grit-blasted steel, and phosphatized steel), lead, aluminum, copper, brass, bronze, nickel, zinc, and the like. Typical metal shapes for seals are stamped rings, tubes, and the like. Rubber tearing bonding to metal is achieved with the adhesive in the absence of a cover coat adhesive, although it is envisioned that a cover coat adhesive could be employed. The adhesives provide pre-bake resistance at 300° F. for at least 3 minutes with at least 80% rubber retention to the metal bond area. To bond the various substrates described above, the present adhesive may be applied to one or both of the surfaces or substrates to be bonded, after which the substrates are contacted under conditions sufficient to create an adhesive bond.

Phenolic resins having an F/P ratio >1, and multifunctional organic crosslinking agents are absent in present in the adhesive. Exclusion of organic crosslinking components was found to be essential in providing acceptable bonding performance under pre-bake conditions. Representative examples of excluded organic crosslinking agents include: gamma-polyoxomethylene, paraformaldehyde, s-trioxane, hexamethylene tetramine, tri-methylol nitromethane (TMNM), anhydroformaldehyde aniline, ethylene diamine formaldehyde; methylol derivatives of urea and formaldehyde; acetaldehyde; furfural; methylol phenolic compounds, poly-C-nitroso compounds like 1,3-dinitrosobenzene; self-curing resole resins; dioximes whether quinoid or non-quinoid; 4,4′-dihydroxydiphenylsulfone (Bisphenol S); 2,4′-dihydroxydiphenylsulfone; 2,2-isopropylidine-bis(4-hydroxybenzene) (Bisphenol A); 2,2-hexafluoroisopropylidine-bis(4-hydroxybenzene) (Bisphenol AF), 4,4′-dihydroxybenzophenone; 4,4′-biphenol; 1-allyloxy-4-hydroxybenzene; bisphenol A monoallyl ether; dicarbonate blocked Bisphenol AF compounds; 1,4-bis(hydroxymethyl)perfluorobutane, hexamethylenediamine carbamate; N,N′-dicinnamylidene-1,6-hexanediamine; quinolines, like 2,2,4-trimethyl-1,2-dihydroquinoline and oligomers thereof, and 6-methyl-,6-ethoxy-,6-dodecyl-or 6-phenyl-2,2,4-trimethyl-1,2-dihydroquinoline and oligomers thereof, bis-maleimides, and poly maleimides, and the like. According to one theory, the adhesive, absent organic crosslinkers, in air, under the influence of heat and acid acceptors may cure more slowly as a result of alkylation reactions and oxidation of the phenolic resin which may give rise to in situ-formed structures which can crossbridge to the elastomer and/or to chlorinated natural rubber by available pathways, including the result of the action of sulfur curatives and accelerators present in the curable elastomer compound. The resulting latent curing is sufficient as evidenced by the outstanding performance in environmental testing, and should be a result of a tough network of crossbridging between oxidized, and/or alkylated phenolic, natural rubber, and cured elastomer.

Bonded Elastomers.

The adhesive will bond a variety of single, or multi-layered elastomer polymers, but is most outstanding in bonding elastomers which are vulcanized using a variety of sulfur cure packages in the case of NBR, and diamine cured elastomers such as ethylene-(meth)acrylic acid copolymers (EEA). Although in a few special instances, both a sulfur-curing component and a peroxide curing component can both be present. The vulcanizable elastomers are known to be difficult to bond to substrates, especially to metal substrates. Surprisingly, it has been discovered that the adhesive compositions of the present invention provide environmentally resistant adhesion at a high degree of cohesive failure of cured elastomer to the metal substrate containing the adhesive, and this is observed for NBR and EEA elastomers, typically employed for dynamic seal constructions. An exhaustive listing of polymers suitably bonded is beyond the scope of this disclosure.

In general, bonding can be achieved between the adhesive and homopolymers of conjugated diene compounds such as isoprene, butadiene, and chloroprene. Examples include polyisoprene rubber (IR), polybutadiene rubber (BR), natural rubber (NR) and polychloroprene rubber; and especially copolymers of a conjugated diene compound and other monomer(s) such as styrene, acrylonitrile, vinylpyridine, vinylidene halide, acrylic acid, methacrylic acid, alkyl acrylate, and alkyl methacrylate. Specific examples of diene copolymers include styrene-butadiene copolymer rubber, vinylpyridine butadiene styrene terpolymer rubber, carboxylated or non-carboxylated acrylonitrile butadiene copolymer rubber(NBR), hydrogenated acrylonitrile butadiene copolymer rubber(HNBR), ZSC-cured hydrogenated nitrile-butadiene rubber, acrylic acid butadiene copolymer rubber, methacrylic acid butadiene copolymer rubber, methyl acrylate butadiene copolymer rubber, and methyl methacrylate butadiene copolymer rubber. Other bondable elastomers suitable herein are copolymers of olefin with non-conjugated dienes, or olefins and α,β-unsaturated carboxylic acids and/or esters. Specific ethylene copolymers include ethylene-propylene-diene (EPDM), ethylene-propylene-5-ethylidene-2-norbornene terpolymer, and ethylene-propylene-1,4-hexadiene terpolymer, and ethylene-methacrylic acid.

The following compounds are representative of elastomer compounds suitable for bonding to metal and other substrates according to the invention.

NBR rubber: 100 parts by weight nitrile rubber (33% acrylonitrile); 1-1.5 parts by weight stearic acid; 4-6 parts by weight zinc oxide; 4-6 parts by weight dioctylphthalate; 40-50 parts by weight carbon black; 1.6-2.0 parts by weight N-cyclohexyl-2-benzothiazylsulfenamide; and about 2 parts by weight sulfur. The usual vulcanizing conditions for this compound are: 15 minutes at 150° C.

The Rubber Formulary, by Peter A. Ciullo and Norman Hewitt; (1999) Noyes Publications, Norwich, N.Y., p. 678 discloses the following suitable elastomer seal compound:

| | Wt. parts |
|---|---|
| Vamac ® G | 100 |
| Stearic Acid | 1.00 |
| Armeen ® 18D | 0.5 |
| Vanfre ® Vam | 2.0 |
| FEF Black N-550 | 60 |
| Graphite | 20.0 |
| dioctyl phthalate | 10.0 |
| Vanox ® ZMTI | 2.0 |
| Vanox ® AM | 1.0 |
| Vanax ® DOTG | 4.0 |
| Diak ® No. 1 | 1.25 |

A general compound suitable for such ethylene copolymers like Vamac® is disclosed in Rubber Technology, 3^{RD} Ed., Maurice Morton, (1995) Chapman & Hall, London; pg. 334

| | Wt. Parts |
|---|---|
| Vamac ® B-124 | 124 |
| N774 SRF-HM Black | 55 |
| Methylene dianiline | 1.25 |
| Diphenylguanidine | 4 |

Bonded elastomers may include laminates of two elastomers. More than one layer of elastomer may be incorporated into the bonded composites according to the invention. Prior to contacting the adhesive coated metal seal substrate, there may be a lamination of two or more elastomers, or a co-extrusion, or co-injection molding.

Besides the aforementioned essential adhesive components, there can be optionally included other known additives such as plasticizers, coupling agents, mineral fillers, pigments, colorants, reinforcing agents, and the like, in conventional amounts. Carbon black is preferentially used. Carbon blacks such as those having low to high DBP absorption as from about 50 to about 160 cm³/100 g over a wide range of nitrogen adsorption as from about 20 to about 150 (m²/g) being suitable. Carbon black contributes to a modulus increase, and adhesive sweep resistance. The amount of carbon black employed can be generally very small, such as from about 0.5 to about 10 parts of dry weight for every 100 parts of dry weight of the phenolic resin.

In forming the adhesive compositions of the invention, the novolak phenolic resin is preferably pre-dispersed in water and added to a masterbatch of the pigment grind, followed by addition of chlorinated natural rubber latex. As is known in the art, relatively low molecular weight novolak resins with F/P ratios approximately 0.5 can be dispersed in water alone. With novolak resins higher in molecular weight and/or with a higher F/P ratios approaching 0.9, a base, such as sodium hydroxide aids in rendering the resin soluble in the water. A solid, water-insoluble novolak resin may require an organic co-solvent solvent like glycol ether, or ketone and the like.

The adhesive compositions of the present invention may be prepared by usual and customary methods known in the art, but are preferably prepared by combining and milling or shaking the ingredients and water in a ball-mill, sand-mill, pebble-mill, ceramic bead-mill, steel bead-mill, high speed media-mill, or the like. It is preferred that solid insoluble materials be finely ground to a Hegman® gauge of 0.0005-0.001 in.

As a single-package, aqueous adhesive composition, they are storage-stable at ambient temperatures, have adequate pot-life; and exhibit excellent layover qualities, i.e., the compositions can be applied to a substrate, allowed to dry and remain in storage in their dry and uncured state for an extended time at ambient temperatures, and then cured with the aid of heat at the time of manufacture of bonded composites, and significantly extended pre-bake resistance by remaining in a thermoplastic state until chemical bonds develop during the vulcanization cycle for the elastomer.

The typical use of the adhesive entails contacting the adhesive surface on the metal with the uncured rubber under a pressure of from about 10 to 200 MPa, preferably from about 20 MPa to 50 MPa, such as by compression molding, injection molding, or transfer molding. The rubber-metal assembly is then heated to the designated vulcanization temperature, from 140° C. to 210° C., and preferably from about 175° C. to 200° C. The composite assembly remains under the applied pressure and temperature for the rubber cure cycle, of from about 1 minute to 60 minutes, depending on the elastomer type, the compound cure rate and the thickness of the molded shape for the elastomer. This process may be carried out by applying the rubber substrate as a semi-molten material to the metal surface as in, for example, an injection-molding process. Although preferred for use in bonding sulfur-cured, and ethylene-acrylic rubber to a metal surface, the present adhesive compositions may be applied as an adhesive to any surface or substrate capable of receiving the adhesive.

The following examples are provided for the purpose of illustration only and are not intended to limit the scope of the present invention which is defined by the claims. All parts and percentages are by weight unless otherwise indicated. Bond strength and failure modes are evaluated using ASTM D429-method B.

### Example 1

The following materials are combined.

| | | | Wet wt. | Dry wt. |
|---|---|---|---|---|
| Example 1 | | | (gms) | (gms.) |
| Phenolic Novolak* (47.7% solids) | | | 11.66 | 5.56 g |
| Chlor. natural rubber latex (50% solids) | | | 11.66 | 5.83 g |
| | | Wt. (gms) | | |
| masterbatch | lignosulfonate | 0.22 | | |
| | Zinc Oxide | 4.03 | | |
| | Silica | 2.74 | | |
| | Carbon black | 1.61 | | |
| | DI Water | 68.8 | | |

*phenol/resorcinol/formaldehyde resin (F/P < 1)

The dry ingredients were combined with Dl water in a masterbatch and run through a sandmill until a Hegman grind of less than 1.5 mils was obtained. The phenolic resin (pyrogallol-resorcinol-formaldehyde novolak resin) was stirred into the masterbatch with a paddle mixer and allowed to mix for 15 minutes to neutralize any free acid. After 15 minutes chlorinated natural rubber latex was added to the mixture and stirred with a paddle mixer until homogeneous (30 minutes).

The adhesive composition prepared from Example 1 was coated onto 0.125 inch (3.1 mm) phosphatized steel coupons, and dried to a dry film thickness (DFT) of 0.0003 in. (0.0076 mm) and the adhesive-coated coupons were bonded to different rubber stocks by compression molding at 430° F. (221° C.) after specified pre-bake time. The resulting bonded parts were pulled to destruction at room temperature, according to ASTM test D429-Method B. The results are shown in the following Tables, noting any dwell time and pre-bake time, and cure conditions for the vulcanized rubber.

Failure mode is noted as percent rubber retained on the bond area. SB=Stock Break; R=rubber cohesive failure (desired); RC=Rubber-to-cement failure; CM=Cement-to-metal failure, and RT under Rubber failure denotes a thin rubber failure mode (undesirable). At least 80% Rubber retained (rubber cohesive failure) in the bond area on the metal substrate is generally accepted.

Primary Adhesion - ASTM- D429 method B
360° F. (182° C.) pre-bake
Rubber stock: Vamac ® rubber compound cured 10′ @ 360° F.
(182° C.)

| | 0′ | 15′ | 30′ | 45′ | 60′ |
|---|---|---|---|---|---|
| Adhesive | pre-bake | pre-bake | pre-bake | pre-bake | pre-bake |
| Example 1 | 100 R | 100 R | 100 R | 100 R | 100 R |
| Comm. A* | 100 R | 67 R | 20 R | 0 R | 0 R |
| Comm. B* | 100 R | 60 R | 0 R | 0 R | 0 R |
| Comm. C** | 100 R | 100 R | 100 R | 100 R | 100 R |

*Comm. A and B are aqueous adhesives containing phenolic novolak resin, latent formaldehyde donor crosslinkers and chlorosulfonated polyolefin latex.
**Comm. C is a solvent-based adhesive, containing chlorinated natural rubber and self-crosslinking phenolic resin.

370° F. (187° C.) Pre-bake
Example 1 bonded to NBR rubber compound cured at 6′ @ 370° F.
(187° C.)

| | 0′ | 15′ | 30′ | 45′ | 60′ |
|---|---|---|---|---|---|
| Adhesive | pre-bake | pre-bake | pre-bake | pre-bake | pre-bake |
| Example 1 | 100 R | 0 R | 20 R | 100 R | 100 R |
| Comm. A | 100 R | 0 R | 0 R | 0 R | 0 R |
| Comm. B | 100 R | 0 R | 0 R | 0 R | 0 R |
| Comm. C | 100 R | 100 R | 100 R | 100 R | 100 R |

300° F. Dwell Plus 350° F. Pre-bake
Example 1 bonded to commercial NBR cured 6′ @ 350° F.

| | (Min.) @ 300° F. | | | |
|---|---|---|---|---|
| | + 0′ prebake | + 3′ prebake | + 6′ prebake | + 9′ prebake |
| | 100 R | 100 R | 73 R | 97 R |
| 3′ | 100 R | 100 R | 90 R | 97 R |
| 6′ | 100 R | 100 R | 87 R | 97 R |
| 9′ | 100 R | 100 R | 67 R | 97 R |

300° F. Dwell plus 350° F. Pre-bake
Example 1 bonded to commercial Vamac cured 6′ @ 350° F.

| | (Min.) @ 300 F | | | |
|---|---|---|---|---|
| | + 0′ prebake | + 3′ prebake | + 6′ prebake | + 9′ prebake |
| 0′ | 100 R | 100 R | 100 R | 100 R |
| 3′ | 100 R | 100 R | 100 R | 100 R |
| 6′ | 100 R | 100 R | 100 R | 97 R |
| 9′ | 100 R | 100 R | 100 R | 97 R |

300° F. Dwell plus 350° F. Pre-bake
Example 1 bonded to commercial NBR cured 6′ @ 350° F.

| | (Min.) @ 300 F | | | |
|---|---|---|---|---|
| | + 0′ prebake | + 3′ prebake | + 6′ prebake | + 9′ prebake |
| 0′ | 100 R | 100 R | 100 R | 100 R |
| 3′ | 100 R | 100 R | 100 R | 100 R |
| 6′ | 100 R | 100 R | 100 R | 97 R |
| 9′ | 100 R | 100 R | 83 R | 67 R |

| Adhesive system | 0′ pre-bake | 5′ pre-bake |
|---|---|---|
| Primary Adhesion to commercial NBR | | |
| Example 1 | 100 R | 97 R |
| Commercial A | 100 R | 0 R |
| Commercial B | 100 R | 0 R |
| Commercial C | 100 R | 100 R |
| 7 Day Oil exposure at 300° F. (commercial NBR) | | |
| Example 1 | 100 R | 100 R |
| Commercial A | 100 R | 100 R |
| Commercial B | 100 R | 100 R |
| Commercial C | 100 R | 100 R |

7 Day Oil exposure at 300° F. (commercial NBR)

| Adhesive system | 0′ pre-bake | 5′ pre-bake |
|---|---|---|
| Example 1 | 100 R | 100 R |
| Commercial A | 100 R | 100 R |
| Commercial B | 100 R | 100 R |
| Commercial C | 100 R | 100 R |

7 day 150° F. water immersion
with 1% cascade (commercial NBR)

| Adhesive system | 0′ pre-bake | 5′ pre-bake |
|---|---|---|
| Example 1 | 60 R | 73 R |
| Commercial A | 100 R | 0 R |
| Commercial B | 100 R | 0 R |
| Commercial C | 53 R | 0 R |

Primary Adhesion (Commercial Vamac ® rubber)

| Adhesive system | 0′ pre-bake | 5′ pre-bake |
|---|---|---|
| Example 1 | 100 R | 97 R |
| Commercial A | 100 R | 100 R |
| Commercial B | 100 R | 100 R |
| Commercial C | 100 R | 100 R |

7 Day Oil exposure at 300° F. (Vamac ® rubber)

| Adhesive system | 0′ pre-bake | 5′ pre-bake |
|---|---|---|
| Example 1 | 100 R | 100 R |
| Commercial A | 100 R | 100 R |
| Commercial B | 100 R | 100 R |
| Commercial C | 100 R | 100 R |

7 Day water immersion at 150° F. with
1% cascade (Vamac ® rubber)

| Adhesive system | 0′ pre-bake | 5′ pre-bake |
|---|---|---|
| Example 1 | 100 R | 100 R |
| Commercial A | 100 R | 80 R |
| Commercial B | 77 R | 100 R |
| Commercial C | 53 R | 97 R |

24 Hr. - 41° C. @ 100% humidity - Example 1

| Rubber Stocks | 0′ pre-bake | 5′ pre-bake |
|---|---|---|
| NBR1 | 100 R | 100 R |
| NBR2 | 87 R | 100 R |
| NBR3 | 97 R | 100 R |

### Example 2

The following formula was combined into adhesives for Example 2 and coated to the same DFT on the same zinc phosphatized coupons used in Example 1. Examples in this series compared adhesives containing chlorinated natural rubber latex vs. chlorosulfonated polyethylene (CSM), with and without tri-methylol nitromethane (TMNM) crosslinker. The tables below show the effect of latex type and crosslinker on adhesion performance under pre-bake conditions.

| | | | Wet wt. | Dry wt. |
|---|---|---|---|---|
| Example 1 | | | (gms) | (gms.) |
| Phenolic Novolak* (47.7% solids) | | | 11.66 | 5.56 g |
| latex - as indicated | | | 11.66 | 5.83 g |
| | | Wt. (gms) | | |
| masterbatch | lignosulfonate | 0.22 | | |
| | Zinc Oxide | 4.03 | | |
| | Silica | 2.74 | | |
| | Carbon black | 1.61 | | |
| | DI Water | 68.8 | | |

*phenol-resorcinol-formaldehyde resin (F/P < 1)

Examples

| | | |
|---|---|---|
| 2A | chlorosulfonated polyethylene + 0.5% TMNM | comparative |
| 2B | chlorinated natural rubber latex + 0.5% TMNM | comparative |
| 2C | chlorosulfonated polyethylene + 1% TMNM | comparative |
| 2D | chlorinated natural rubber latex (C-NR) + 1% TMNM | comparative |
| 2E | chlorosulfonated polyethylene + 2% TMNM | comparative |
| 2F | chlorinated natural rubber latex + 2% TMNM | comparative |
| 2G | chlorosulfonated polyethylene + 3% TMNM | comparative |
| 2H | chlorinated natural rubber latex + 3% TMNM | comparative |
| 2I | chlorinated natural rubber latex + no TMNM | invention |
| 2J | chlorosulfonated polyethylene + no TMNM | comparative |

Testing: Primary Adhesion

Bonding to Commercial NBR Elastomer—pre-bake as indicated was at 430° F. (221° C.); rubber was cured 6′@430° F. (221° C.)

| Ad- | 0 minute prebake | | | | Ad- | 5 minute prebake | | | |
|---|---|---|---|---|---|---|---|---|---|
| hesive | SB | R | RC | CM | hesive | SB | R | RC | CM |
| | 0 | 100 | 0 | 0 | | 0 | 100 | 0 | 0 |
| 2 A | 0 | 100 | 0 | 0 | 2 A | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 2 B | 0 | 100 | 0 | 0 | 2 B | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 2 C | 0 | 100 | 0 | 0 | 2 C | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 80 | 20 | 0 |
| 2 D | 0 | 100 | 0 | 0 | 2 D | 0 | 90 | 10 | 0 |
| | 0 | 100 | 0 | 0 | | 0 | 100 | 0 | 0 |
| mean: | 0 | 100 | 0 | 0 | mean: | 0 | 90 | 10 | 0 |
| | 0 | 100 | 0 | 0 | | 0 | 100 | 0 | 0 |
| | | TR | | | | | | | |
| 2 E | 0 | 100 | 0 | 0 | 2 E | 0 | 100 | 0 | 0 |
| | | TR | | | | | | | |
| | 0 | 100 | 0 | 0 | | 0 | 100 | 0 | 0 |
| | | TR | | | | | | | |
| mean: | 0 | 100 | 0 | 0 | mean: | 0 | 100 | 0 | 0 |
| | | TR | | | | | | | |
| | 0 | 100 | 0 | 0 | | 0 | 100 | 0 | 0 |
| | | TR | | | | | | | |
| 2 F | 0 | 100 | 0 | 0 | 2 F | 0 | 80 | 20 | 0 |
| | | TR | | | | | | | |
| | 0 | 100 | 0 | 0 | | 0 | 80 | 20 | 0 |
| | | TR | | | | | | | |
| mean: | 0 | 100 | 0 | 0 | mean: | 0 | 85 | 15 | 0 |
| | | TR | | | | | | | |
| | 0 | 100 | 0 | 0 | | 0 | 100 | 0 | 0 |
| 2 G | 0 | 100 | 0 | 0 | 2 G | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| | | TR | | | | | | | |
| 2 H | 0 | 100 | 0 | 0 | 2 H | 0 | 100 | 0 | 0 |
| | | TR | | | | | | | |
| | 0 | 100 | 0 | 0 | | 0 | 100 | 0 | 0 |
| | | TR | | | | | | | |
| mean: | 0 | 100 | 0 | 0 | mean: | 0 | 100 | 0 | 0 |
| | | TR | | | | | | | |
| | 0 | 100 | 0 | 0 | | 0 | 100 | 0 | 0 |
| 2 I (in- | 0 | 100 | 0 | 0 | 2 I (in- | 0 | 100 | 0 | 0 |
| vention) | | | | | vention) | | | | |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 2 J | 0 | 100 | 0 | 0 | 2 J | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |

| Ad- | 9 minute prebake | | | | Ad- | 12 minute prebake | | | |
|---|---|---|---|---|---|---|---|---|---|
| hesive | SB | R | RC | CM | hesive | SB | R | RC | CM |
| | 0 | 30 | 70 | 0 | | 0 | 100 | 0 | 0 |
| 2 A | 0 | 30 | 70 | 0 | 2 A | 0 | 100 | 0 | 0 |
| | 0 | 90 | 10 | 0 | | 0 | 80 | 20 | 0 |
| | | TR | | | | | | | |
| mean: | 0 | 50 | 50 | 0 | mean: | 0 | 93 | 7 | 0 |
| | 0 | 100 | 0 | 0 | | 0 | 100 | 0 | 0 |
| 2 B | 0 | 100 | 0 | 0 | 2 B | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 90 | 10 | 0 | | 0 | 50 | 50 | 0 |
| 2 C | 0 | 100 | 0 | 0 | 2 C | 0 | 100 | 0 | 0 |
| | 0 | 90 | 10 | 0 | | 0 | 100 | 0 | 0 |
| mean: | 0 | 93 | 7 | 0 | mean: | 0 | 83 | 17 | 0 |
| | 0 | 100 | 0 | 0 | | 0 | 80 | 20 | 0 |
| 2 D | 0 | 100 | 0 | 0 | 2 D | 0 | 90 | 10 | 0 |
| | 0 | 100 | 0 | 0 | | 0 | 90 | 10 | 0 |
| mean: | 0 | 100 | 0 | 0 | mean: | 0 | 87 | 13 | 0 |
| | 0 | 90 | 10 | 0 | | 0 | 0 | 100 | 0 |
| 2 E | 0 | 90 | 10 | 0 | 2 E | 0 | 80 | 20 | 0 |
| | 0 | 0 | 100 | 0 | | 0 | 30 | 70 | 0 |
| mean: | 0 | 60 | 40 | 0 | mean: | 0 | 37 | 63 | 0 |
| | 0 | 100 | 0 | 0 | | 0 | 100 | 0 | 0 |
| 2 F | 0 | 100 | 0 | 0 | 2 F | 0 | 80 | 20 | 0 |
| | 0 | 100 | 0 | 0 | | 0 | 70 | 30 | 0 |
| mean: | 0 | 100 | 0 | 0 | mean: | 0 | 83 | 17 | 0 |
| | 0 | 100 | 0 | 0 | | 0 | 90 | 10 | 0 |
| 2 G | 0 | 100 | 0 | 0 | 2 G | 0 | 90 | 10 | 0 |
| | 0 | 0 | 100 | 0 | | 0 | 90 | 10 | 0 |
| mean: | 0 | 67 | 33 | 0 | mean: | 0 | 90 | 10 | 0 |
| | 0 | 100 | 0 | 0 | | 0 | 100 | 0 | 0 |
| 2 H | 0 | 100 | 0 | 0 | 2 H | 0 | 50 | 50 | 0 |
| | 0 | 80 | 20 | 0 | | 0 | 30 | 70 | 0 |
| mean: | 0 | 93 | 7 | 0 | mean: | 0 | 60 | 40 | 0 |
| | 0 | 100 | 0 | 0 | | 0 | 100 | 0 | 0 |
| 2 I (in- | 0 | 100 | 0 | 0 | 2 I (in- | 0 | 100 | 0 | 0 |
| vention) | | | | | vention) | | | | |
| | 0 | 100 | 0 | 0 | | 0 | 100 | 0 | 0 |
| mean: | 0 | 100 | 0 | 0 | mean: | 0 | 100 | 0 | 0 |
| | 0 | 90 | 10 | 0 | | 0 | 20 | 80 | 0 |
| 2 J | 0 | 90 | 10 | 0 | 2 J | 0 | 20 | 80 | 0 |
| | 0 | 90 | 10 | 0 | | 0 | 20 | 80 | 0 |
| mean: | 0 | 90 | 10 | 0 | mean: | 0 | 20 | 80 | 0 |

### Example 3

The following adhesives were formulated using different chlorinated polymer latexes, chlorosulfonated polyethylene (CSM), chlorinated natural rubber lates, and a homopolymer of 2,3-dichlorod butadiene latex to compare the effect of substituting for chlorinated natural rubber. The comparison includes the effect of substituting a novolak resin with resole resins. TSC refers to total solids content in weight %.

| Example 3 | | | Wet wt. (gms) |
|---|---|---|---|
| Phenolic Novolak* (type indicated below) | | | 12.07 |
| Latex** (type indicated below) | | | 12.07 |
| | | Wt. (gms) | |
| Masterbatch | lignosulfonate | 0.224 | |
| | Zinc Oxide | 4.07 | |
| | Silica | 2.78 | |
| | Carbon black | 0.678 | |
| | TiO₂ | 1.36 | |
| | DI Water | 67.168 | |

| Example | *Phenolic TSC (wt. %) | ** latex (TSC) (wt. %) |
|---|---|---|
| 3-A(invention) | novolak (Ex. 1) (47.7) | C-NR (50%) |
| 3-B | novolak B³ 20% | C-NR (50%) |
| 3-C | resole resin^{†} 51% | C-NR (50%) |
| 3-D | resole resin^{‡} 47% | C-NR (50%) |
| 3-E | novolak (Ex. 1) (47.7) | 43%-chlorine CSM (50%) |
| 3-F | novolak (Ex. 1) (47.7) | 24% Chlorine CSM (50%) |
| 3-G | novolak (Ex. 1) (47.7) | 2,3-DCD latex (35.73%) |

³(DHNS-phenol-catechol-resorcinol F/P < 1 Example 1, U.S. Pat. No. 6,383,307 )
^{†}GP-4001, ex. Ga. Pacific
^{‡}BKUA 2370, ex. Dow Chemical

Primary Adhesion

| Ad- | 0 minute prebake | | | | Ad- | 3 minute prebake | | | |
|---|---|---|---|---|---|---|---|---|---|
| hesive | SB | R | RC | CM | hesive | SB | R | RC | CM |
| | 0 | 100 | 0 | 0 | | 0 | 100 | 0 | 0 |
| 3 A | 0 | 100 | 0 | 0 | 3 A | 0 | 100 | 0 | 0 |
| | 0 | 80 | 20 | 0 | | 0 | 100 | 0 | 0 |
| mean: | 0 | 93 | 7 | 0 | mean: | 0 | 100 | 0 | 0 |
| | 0 | 100 | 0 | 0 | | 0 | 100 | 0 | 0 |
| 3 B | 0 | 100 | 0 | 0 | 3 B | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 C | 0 | 100 | 0 | 0 | 3 C | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 D | 0 | 100 | 0 | 0 | 3 D | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 0 | 100 | 0 | | 0 | 0 | 100 | 0 |
| 3 E | 0 | 0 | 100 | 0 | 3 E | 0 | 0 | 100 | 0 |
| | 0 | 100 | 0 | 0 | | 0 | 30 | 70 | 0 |
| mean: | 0 | 33 | 67 | 0 | mean: | 0 | 10 | 90 | 0 |
| | 0 | 100 | 0 | 0 | | 0 | 0 | 100 | 0 |
| 3 F | 0 | 0 | 100 | 0 | 3 F | 0 | 0 | 100 | 0 |
| | 0 | 0 | 100 | 0 | | 0 | 60 | 40 | 0 |
| mean: | 0 | 33 | 67 | 0 | mean: | 0 | 20 | 80 | 0 |
| | 0 | 0 | 100 | 0 | | 0 | 0 | 100 | 0 |
| 3 G | 0 | 0 | 100 | 0 | 3 G | 0 | 0 | 100 | 0 |
| | 0 | 0 | 100 | 0 | | 0 | 0 | 100 | 0 |
| mean: | 0 | 0 | 100 | 0 | mean: | 0 | 0 | 100 | 0 |

Primary Adhesion

| Ad- | 6 minute prebake | | | | Ad- | 9 minute prebake | | | |
|---|---|---|---|---|---|---|---|---|---|
| hesive | SB | R | RC | CM | hesive | SB | R | RC | CM |
| | 0 | 100 | 0 | 0 | | 0 | 100 | 0 | 0 |
| 3 A | 0 | 100 | 0 | 0 | 3 A | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 B | 0 | 100 | 0 | 0 | 3 B | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 C | 0 | 100 | 0 | 0 | 3 C | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 D | 0 | 100 | 0 | 0 | 3 D | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 100 | 0 | 0 | | 0 | 100 | 0 | 0 |
| 3 E | 0 | 100 | 0 | 0 | 3 E | 0 | 100 | 0 | 0 |
| | 0 | 100 | 0 | 0 | | 0 | 100 | 0 | 0 |
| mean: | 0 | 100 | 0 | 0 | mean: | 0 | 100 | 0 | 0 |
| | 0 | 0 | 100 | 0 | | 0 | 0 | 100 | 0 |
| 3 F | 0 | 0 | 100 | 0 | 3 F | 0 | 70 | 30 | 0 |
| | 0 | 0 | 100 | 0 | | 0 | 30 | 70 | 0 |
| mean: | 0 | 0 | 100 | 0 | mean: | 0 | 33 | 67 | 0 |
| | 0 | 0 | 100 | 0 | | 0 | 0 | 100 | 0 |
| 3 G | 0 | 0 | 100 | 0 | 3 G | 0 | 0 | 100 | 0 |
| | 0 | 0 | 100 | 0 | | 0 | 0 | 100 | 0 |
| mean: | 0 | 0 | 100 | 0 | mean: | 0 | 0 | 100 | 0 |

Primary adhesion
12 minute prebake

| Adhesive | SB | R | RC | CM |
|---|---|---|---|---|
| | 0 | 100 | 0 | 0 |
| 3A | 0 | 100 | 0 | 0 |
| | 0 | 100 | 0 | 0 |
| mean: | 0 | 100 | 0 | 0 |
| | 0 | 100 | 0 | 0 |
| 3B | 0 | 100 | 0 | 0 |
| | 0 | 100 | 0 | 0 |
| mean: | 0 | 100 | 0 | 0 |
| | 0 | 100 | 0 | 0 |
| 3C | 0 | 100 | 0 | 0 |
| | 0 | 100 | 0 | 0 |
| mean: | 0 | 100 | 0 | 0 |
| | 0 | 100 | 0 | 0 |
| 3D | 0 | 100 | 0 | 0 |
| | 0 | 100 | 0 | 0 |
| mean: | 0 | 100 | 0 | 0 |
| | 0 | 0 | 100 | 0 |
| 3E | 0 | 100 | 0 | 0 |
| | 0 | 80 | 20 | 0 |
| mean: | 0 | 60 | 40 | 0 |
| | 0 | 60 | 40 | 0 |
| 3F | 0 | 60 | 40 | 0 |
| | 0 | 60 | 40 | 0 |
| mean: | 0 | 60 | 40 | 0 |
| | 0 | 0 | 100 | 0 |
| 3G | 0 | 0 | 100 | 0 |
| | 0 | 0 | 100 | 0 |
| mean: | 0 | 0 | 100 | 0 |

Examples 3-A-3-G were evaluated for extended pre-bake at 350° F. (176° C.) for 15 minutes; bonding to sulfur cured NBR, and to Vamac®) rubber. All examples replacing C-NR (3E-3G) failed primary adhesion testing and were not tested under environmental stress conditions.

Bonded samples with sulfur-cured NBR, tested for adhesive failure after 4 days of water immersion with 1% cascading, example 3-A passed this test.

Bonded samples with Vamac® rubber, adhesion testing after 4 days of water immersion with 1% cascading, example 3-A was superior to Examples 3-B-3-G.

24 hour humidity testing

| Ad- | 0 minute prebake | | | | Ad- | 5 minute prebake | | | |
|---|---|---|---|---|---|---|---|---|---|
| hesive | SB | R | RC | CM | hesive | SB | R | RC | CM |
| | 0 | 90 | 10 | 0 | | 0 | 100 | 0 | 0 |
| 3 A | 0 | 70 | 30 | 0 | 3 A | 0 | 100 | 0 | 0 |
| | 0 | 80 | 20 | 0 | | 0 | 100 | 0 | 0 |
| mean: | 0 | 80 | 20 | 0 | mean: | 0 | 100 | 0 | 0 |
| | 0 | 50 | 50 | 0 | | 0 | 50 | 50 | 0 |
| 3 B | 0 | 50 | 50 | 0 | 3 B | 0 | 70 | 30 | 0 |
| | 0 | 80 | 20 | 0 | | 0 | 90 | 10 | 0 |
| mean: | 0 | 60 | 40 | 0 | mean: | 0 | 70 | 30 | 0 |
| | 0 | 100 | 0 | 0 | | 0 | 50 | 50 | 0 |
| 3 C | 0 | 100 | 0 | 0 | 3 C | 0 | 10 | 90 | 0 |
| | 0 | 100 | 0 | 0 | | 0 | 40 | 60 | 0 |
| mean: | 0 | 100 | 0 | 0 | mean: | 0 | 33 | 67 | 0 |
| | 0 | 90 | 10 | 0 | | 0 | 100 | 0 | 0 |
| 3 D | 0 | 80 | 20 | 0 | 3 D | 0 | 100 | 0 | 0 |
| | 0 | 100 | 0 | 0 | | 0 | 70 | 30 | 0 |
| mean: | 0 | 90 | 10 | 0 | mean: | 0 | 90 | 10 | 0 |

24 hour humidity testing - 41° C.
15 minute prebake

| Adhesive | SB | R | RC | CM |
|---|---|---|---|---|
| | 0 | 100 | 0 | 0 |
| 3A | 0 | 100 | 0 | 0 |
| | 0 | 100 | 0 | 0 |
| mean: | 0 | 100 | 0 | 0 |
| | 0 | 40 | 60 | 0 |
| 3B | 0 | 80 | 20 | 0 |
| | 0 | 20 | 80 | 0 |
| mean: | 0 | 47 | 53 | 0 |
| | 0 | 50 | 50 | 0 |
| 3C | 0 | 70 | 30 | 0 |
| | 0 | 40 | 60 | 0 |
| mean: | 0 | 53 | 47 | 0 |
| | 0 | 0 | 100 | 0 |
| 3D | 0 | 0 | 100 | 0 |
| mean: | 0 | 0 | 100 | 0 |

1. An aqueous adhesive composition having pre-bake resistance, said adhesive absent an organic crosslinker, and comprising:
water,
a self-dispersible phenolic novolak having a F/P ratio of less than 1,
an acid acceptor, and
chlorinated natural rubber latex.

2. An aqueous adhesive composition according to claim 1, wherein the adhesive comprises, on the basis of 100% by weight:
water 60 to 70%,
phenolic novolak resin, 5 to 15% solids,
acid acceptor 2 to 10% solids, and
chlorinated natural latex 5 to 15% solids.

3. An aqueous adhesive composition of claim 1 further comprising
silica and carbon black.

4. An aqueous adhesive composition according to claim 3, wherein said silica has an average particle size of from about 0.010 to about 0.030 microns and a surface area of from about 130 to about 170 square meters per gram, and wherein said chlorinated natural rubber contains from about 60% to about 75% by weight of chlorine based upon the total weight of said chlorinated natural rubber.

5. An aqueous adhesive composition according to claim 1, wherein said acid acceptor is selected from the group consisting of zinc oxide, zinc phosphate, calcium carbonate, lead salt, or combinations thereof.

6. An aqueous adhesive composition according to claim 1 wherein said chlorinated natural rubber contains from 50 to 75 wt. % chlorine.

7. An aqueous adhesive composition according to claim 1, wherein said phenolic novolak resin is a condensation product of a monohydroxy and/or dihydroxy phenolic compound, a trihydroxy phenolic compound and formaldehyde, having an F/P ratio of from 0.5-0.8.

8. An aqueous adhesive composition according to claim 1, wherein said phenolic novolak resin comprises a co-solvent, and the condensation product of a monohydroxy and dihydroxy phenolic compounds and formaldehyde, said resin has a F/P ratio of from 0.5-0.8.

9. An aqueous adhesive composition according to claim 1, wherein said composition exhibits at least 80% rubber cohesive failure to a metal substrate after exposure to a pre-bake condition of 300° F. or higher for at least 3 minutes.

10. An aqueous adhesive composition according to claim 9, wherein said cohesive failure occurs after a pre-bake condition of 300° F. or higher for at least 6 minutes.

11. An aqueous adhesive composition according to claim 10, wherein said cohesive failure occurs after a pre-bake condition of at least 300° F. for 9 minutes.

12. An aqueous adhesive composition according to claim 1 wherein said phenolic resin self-disperses in water, co-solvent, and base, wherein said phenolic novolak has a molecular weight of from 500 to 3000.

13. A rubber metal composite bonded by the adhesive composition of claim 1.

14. An elastomer-metal seal comprising a cured rubber portion bonded to a an adhesive coated metal portion and an single layer of adhesive therebetween, said adhesive is absent an organic crosslinker, and comprises prior to drying, water, a phenolic novolak resin having a F/P ratio of less than 1, an acid acceptor and chlorinated natural rubber.
